(19) United States
(12) Patent Application Publication
(10) Pub. No.: US 2003/0234351 A1
(43) Pub. Date: Dec. 25, 2003

(54) Brightness independent optical position sensor

(76) Inventor: Chong-Hin Chee, Penang (MY)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/369,941

(22) Filed: Feb. 20, 2003

(30) Foreign Application Priority Data
Jun. 25, 2002 (MY) PI20022388

(51) Int. Cl. G01D 5/34

(52) U.S. Cl. 250/231.13

(57) ABSTRACT

A brightness independent optical position sensor, comprising a first photodetector and a second photodetector, an encoding means which interferes with a path of light incident on the first and second photodetectors such that when the light received by the first photodetector increases, the light received by the second photodetector decreases correspondingly in a complementary manner, and an optical comparator unit which receives a first photocurrent and a second photocurrent from the first photodetector and the second photodetector, respectively, and produces an unique output signal which is proportional to a function of the first and second photocurrents.

The present invention relates to an optical position sensor which is independent of the brightness from a light source.

Optical position sensors are commonly found in joystick applications, wherein an encoding means usually in a form of a disc is used to obstruct the path of light to an arrangement of photodetectors. The disc is attached to the shaft of the joystick, and the disc is arranged such that it interferes with the light path from the light source or an optical emitter to the photodetectors. Therefore, the movement of the joystick moves the position of the disc, and hence affects the amount of light incident on the photodetectors. The photodetectors generate photocurrents which are proportional to the amount of light received, which are also proportional to the position of the joystick. Thus, the position of the joystick can be determined.

U.S. Pat. No. 5,621,207 discloses an electro-optical element for sensing input from a user using an actuating element such as a directional control pad or a joystick. Two photoemitters and a photodetector are positioned such that the paths of light from the photoemitters to the photodetector are obstructed by a flange or skirt from the actuation element. The movement of the actuation element, and hence the obstruction of the light path by the flange or skirt will change. Based on the amount of light received by the photodetector, the direction and magnitude of the movement of the actuation element can be determined.

However, the intensity of light from the optical emitter or photoemitter described in the above applications may not be constant and decrease due to factors like device aging or process variations. Such a decrease in the intensity of the optical emitter results in a lesser amount of light received by the photodetectors, and low photocurrents are generated. The low photocurrents generated under these circumstances may be mistaken as a result of a movement from the disc, hence resulting in a wrong interpretation of the position of the actuation element, or the joystick.

Therefore, an optical position sensor which is independent of the intensity of the light source is desired.

### SUMMARY OF THE INVENTION

According to the present invention, there is provided an optical position sensor arrangement comprising a first photodetector and a second photodetector, an encoding means configured to interfere with a path of light incident on the first and second photodetectors such that when the light received by the first photodetector increases due to movement of the encoding means, the light received by the second photodetector decreases correspondingly in a complementary manner, and an optical comparator unit which receives a first photocurrent and a second photocurrent from the first photodetector and the second photodetector, respectively, and produces an unique output signal which is proportional to a function of the first and second photocurrents.

An optical position sensor in accordance with the invention has the advantage that the sensor can produce a unique output signal dependent on the position of the encoder means but independent of the brightness of light incident on the photodetectors of the sensor.

The light is emitted by a light source, for example an optical emitter onto the photodetectors. The encoding means is used to interfere with the path of light incident on the photodetectors, and depending on the amount of interference, a photocurrent, which is proportional to the amount of light received from the light source, is produced by each of the photodetectors. In accordance with the invention, the photocurrent may also be a photovoltage or any other signal which is proportional to the amount of light received by the photodetectors.

The two input photocurrents are then compared in the optical comparator, which is implemented preferably according to the method disclosed in U.S. Pat. No. 4,259,570, in which a unique output signal, which is proportional to the function of the two input photocurrents is generated. When the output signal increases in a positive direction, it corresponds to a displacement of a device in a given direction, which device is connected to the optical sensor where its displacement is to be detected. Conversely, when the output signal decreases in the positive direction, or increases in a negative direction, it corresponds to a displacement of the device in a direction opposite to the given direction.

When the intensity of the light incident on the photodetectors decreases, the amount of light received by both the photodetectors decrease by the same amount, thereby generating corresponding lower photocurrents. However, the function of the first and second photocurrents are defined such that when the first and second photocurrents change by the same amount, the output value of the function remains unchanged. Therefore, since the output signal produced by the optical comparator is proportional to the function of the photocurrents produced by the first and second photodetectors, the output signal is also not affected by the intensity of the light from the light source. In this way, the optical position sensor which is independent of the brightness of the light source is achieved.

In the preferred embodiment of the invention, the function of the photocurrents is given by the following:

f(I_{Y1}, I_{Y2})=(I_{Y1}−I_{Y2})/(I_{Y1}+I_{Y2})

wherein

I_{Y1} is the first photocurrent, and

I_{Y2} is the second photocurrent.

The optical comparator is implemented according to the disclosure in U.S. Pat. No. 4,259,570. The output signal produced by the optical comparator is linearly proportional to the function of the first and the second photocurrents and hence also linearly proportional to the displacement information represented by the photocurrents. Such a linear relationship is highly desirable as it produces a stable and predictable result for determining a displacement based on the output signal.

In an alternative embodiment, the function of the first and second photocurrents are chosen to be the ratio of the first and the second photocurrents, given by the following:

f(I_{Y1}, I_{Y2})=I_{Y1}/I_{Y2}

The optical comparator is implemented as a divider, and the output signal is proportional to the ratio of the first and second photocurrents. When the intensity of light incident on the photodetectors decreases, the output signal which is proportional to the ratio of the photocurrents remains unchanged, thus giving rise also to a brightness independent solution.

In another aspect of the invention, a further third and fourth photodetectors are arranged such that the encoding means can interfere with the light incident on the third and fourth photodetectors in such a way that when light received by the third photodetectors increases, the light received by the fourth photodetector decreases in a complementary manner. The photodetectors are arranged around a central location, with the first and second photodetectors arranged along a first axis, and the third and fourth photodetectors arranged along a second axis, wherein the first and second axis are at an angle with respect to each other.

A third and fourth photocurrent generated by the third and fourth photodetectors, respectively, are compared in a further optical comparator to generate a further output signal which is proportional to the function of the third and fourth photocurrents, wherein the function of the third and fourth photocurrents is given by the following expression:

f(I_{X1}, I_{X2})=(I_{X1}−I_{X2})/(I_{X1}+I_{X2})

wherein

I_{X1} is the third photocurrent, and

I_{X2} is the fourth photocurrent.

The output signal from the optical comparator provides the displacement information of the device parallel to the first axis, and the further output signal from the further optical comparator provides the displacement information of the device parallel to the second axis. Hence, a brightness independent optical position sensor for sensing a two-dimensional displacement of the device is achieved.

According to a further preferred embodiment of the invention, the first axis and the second axis are perpendicular to each other. Therefore, the first and second photodetectors are arranged perpendicularly to the third and fourth photodetectors. In detecting two-dimensional movement, for example the trackball of a mouse, the displacement is usually represented in the X-Y plane, an the X-axis and the Y-axis are perpendicular to each other. By having the photodetectors to be arranged in the same perpendicular manner, the calculations involved in relating the displacement information represented by the output signals from the optical comparator to the actual displacement of the device which the optical sensor is to determine is minimal.

The encoding means comprises an L-shaped element such that when the encoding means interferes with the path of light, an L-shaped shadow of the L-shaped encoding element is cast on the photodetectors. The first and second photodetectors are arranged such that a first leg of the L-shaped encoding means is able to interfere with the path of light incident on the first and second photodetectors, and the third and fourth photodetectors are arranged such that a second leg of the L-shaped encoding element of the encoding means is able to interfere with the path of light incident on the third and fourth photodetectors.

The encoding means comprising the L-shaped element with the corresponding photodetectors arrangement creates a more space-efficient layout, wherein the optical sensor can be placed at a corner of a substrate, allowing more space for other circuitries. A further advantage of this arrangement allows the first and second photodetectors parallel to the first axis to be arranged separately from the third and fourth photodetectors parallel to the second axis. The separated or de-centralised arrangement of the photodetector pairs allows a much simpler way of extracting the displacement information from the photodetectors of the first and second axis.

In another alternative embodiment of the invention, the function of the third and fourth photocurrents are chosen to be the ratio of the third and the fourth photocurrents, given by the following:

f(I_{X1}, I_{X2})=I_{X1}/I_{X2}

The further optical comparator is implemented as a divider, and the further output signal is proportional to the ratio of the third and fourth photocurrents.

The above and other objects, features and advantages of the invention will become apparent from the following description and the appended claims, taken in conjunction with the accompanying drawings in which like parts or elements are denoted by like reference numbers.

### BRIEF DESCRIPTION OF THE DRAWINGS

FIG. 1 shows the arrangement of the optical position sensor according to the invention.

FIG. 2 shows a graphical relationship between the output signal of the optical comparator and the displacement of the device which is to be detected.

FIG. 3 shows the arrangement of the optical position sensor according to the preferred embodiment of the invention.

### DETAILED DESCRIPTION OF THE INVENTION

The preferred embodiments of the invention will now be described with reference to the accompanying drawings.

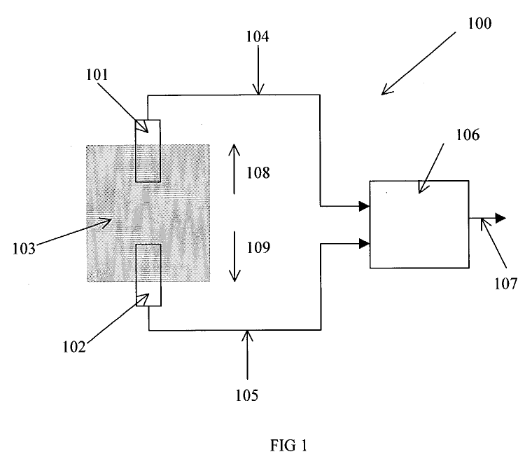

FIG. 1 shows the arrangement of the brightness independent optical position sensor 100 according to the invention.

The first photodetector 101 and the second photodetector 102 are arranged on a substrate (not shown), and light is emitted from a light source (not shown) onto the photodetectors 101, 102. An encoding means 103 is arranged in the path of the light source to the photodetectors 101, 102 so that it can interfere with the path of light, preventing a part of the light from reaching the photodetectors 101, 102.

A first photocurrent 104 and a second photocurrent 105 is generated by the first photodetector 101 and the second photodetector 102, respectively. The first and second photocurrents 104, 105 are received into an optical comparator 106, where the first and second photocurrents 104, 105 are compared. An output signal 107 is generated by the optical comparator 106, which is proportional to the function of the first and second photocurrents 104, 105.

The encoding means 103 is arranged in such a way that it interferes or obstructs a part of the light from the light source to the photodetectors 101, 102, resulting the photodetectors 101, 102 to receive a lesser amount of light.

The encoding means is free to move and is connected, directly or indirectly, to a device which the movement of the device is to be detected. When the device moves, it causes the encoding means 103 to move, resulting the light incident on the photodetectors 101, 102 to change in a corresponding manner.

When the encoding means 103 moves in an upward direction 108, it interfere with the light incident on the first photodetector 101 more and hence a less amount of light is received by the first photodetector 101. Conversely, more light is able to be received by the second photodetector 102 since the encoding means 103 has moved in such a way that less interference or obstruction is provided to the light incident on the second photodetector 102. In other words, the first photodetector 101 and the second photodetector 102 receive light in a complementary manner.

Similarly when the encoding means 103 moves in a downward direction 109, the amount of light received by the first photodetector 101 increases, whereas the amount of light received by the second photodetector 102 decreases correspondingly, in a complementary manner.

The first photocurrent 104, which is proportional to the amount of light received by the first photodetector 101, is generated by the first photodetector 101. The second photocurrent 105, which is proportional to the amount of light received by the second photodetector 102, is also generated by the second photodetector 102.

Both the first and second photocurrents 104, 105 are received by the optical comparator 106, where the optical comparator 106 compares the two photocurrents 104, 105 and produces an analog output signal 107 which is proportional to the function of the photocurrents 104, 105. In the preferred embodiment of the invention, the optical comparator 106 is implemented according to the disclosure in U.S. Pat. No. 4,259,570 and the first and second photocurrents are related by the following function:

f(I_{Y1}, I_{Y2})=(I_{Y1}−I_{Y2})/(I_{1Y}+I_{Y2}) (1)

wherein

I_{Y1} is the first photocurrent, and

I_{Y2} is the second photocurrent.

The output signal 107 produced by the optical comparator 106 is an output current 107 which is related to the first and second photocurrents 104, 105 by the following:

I_{Yout}=CY*(I_{Y1}−I_{Y2})/(I_{Y1}+I_{Y2}) (2)

wherein

I_{Yout} is the output current 107, and

CY is a constant.

From (2), it can be seen that when the encoding plate is at the central or neutral position, the amount of light incident on both the first and second photodetectors 101, 102 are equal, resulting in the first and second photocurrents 104, 105 generated to be equal. In this case, the output current 107 generated by the first optical comparator 106 is zero, indicating no movement of the device attached to the encoding means 103 is detected.

When the encoding means 103 moves in the upward direction 108, the first photocurrent 104 I_{Y1} decreases and the second photocurrent 105 I_{Y2} increases. Therefore, the output current 107 I_{Yout} is a negative value. The magnitude of the output current 107 provides the information on the magnitude of the displacement of the device, and the sign of the output current 107 provides the information on the direction of the displacement of the device.

When the encoding means 103 moves in the downward direction 109, the first photocurrent 104 I_{Y1} increases and the second photocurrent 105 I_{Y2} decreases. Therefore, the output current 107 I_{Yout} is now a positive value, indicating that the movement of the device is now in the opposite direction.

It should be noted that (I_{Y1}+I_{Y2}) remains constant when the intensity of light is constant.

In the event that the intensity of the light from the light source decreases for example, due to aging effects, both the first photodetector 101 and the second photodetector 102 will receive a corresponding decrease in the amount of light, and hence the value of the first photocurrent 104 and the second photocurrent 105 decreases in a corresponding manner. Since both the photocurrents 104, 105 decreases by the same corresponding manner, the output current 107 I_{Yout} according to (2) does not change. Therefore, the optical position sensor according to the invention is independent of the brightness or the intensity of the light source for detecting the displacement of the device.

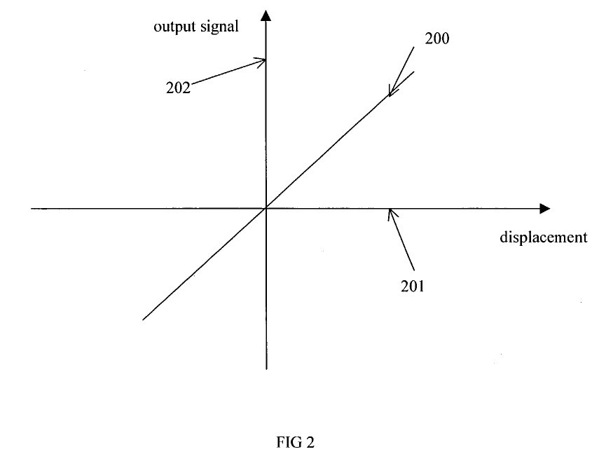

FIG. 2 shows a graphical relationship between the output signal of the optical comparator and the displacement of the device which is to be detected.

The displacement is represented on the horizontal axis 201, and the output signal from the optical comparator is represented on the vertical axis 202. The relationship between the output signal and the displacement is represented by the graph 200.

As seen from FIG. 2, when the output signal increases in the positive direction, the displacement also increases in the positive direction, indicating a larger movement of the device from an initial position along the positive direction. When the output signal increases in the negative direction, the displacement becomes more negative, indicating a movement of the device from an initial position along the negative direction. Therefore, the exact location or movement of the device from an initial position can be determined from the value of the output signal.

It should be pointed out that the exact equation (2) relating the output signal and the photocurrents may be different depending on the device components used for the circuitries to implement the optical comparator. Also the choice of different components used may also produce a graphical relationship between the displacement and output signal which is different from the graphical relationship shown in FIG. 2.

In an alternative embodiment, the first and second photocurrents are related in a ratio by the following function:

f(I_{Y1}, I_{Y2})=I_{Y1}/I_{Y2} (3)

The output current 107 produced by the optical comparator 106 is related to the first and second photocurrents 104, 105 by the following:

I_{Yout}=C1(I_{Y1}/I_{Y2}) (4)

Wherein

C1 is a constant.

From (4), it can be seen that when the encoding plate is at the central or neutral position, the amount of light incident on both the first and second photodetectors 101, 102 are equal, resulting in the first and second photocurrents 104, 105 generated to be equal. In this case, the output current 107 generated by the first optical comparator 106 is equal to the constant C1, indicating no movement of the device attached to the encoding means 103 is detected.

When the encoding means 103 moves in the upward direction 108, the first photocurrent 104 I_{Y1} decreases and the second photocurrent 105 I_{Y2} increases. Therefore, the output current 107 I_{Yout} decreases to a value smaller than C1. The magnitude of the output current 107 with respect to the value C1 provides the information on the magnitude of the displacement of the device, and the information on the direction of the displacement of the device is determined by whether the output current 107 I_{Yout} is greater or smaller than C1.

When the encoding means 103 moves in the downward direction 109, the first photocurrent 104 I_{Y1} increases and the second photocurrent 105 I_{Y2} decreases. Therefore, the output current 107 I_{Yout} increases to a value greater than C1, indicating that the movement of the device is now in the opposite direction.

In the event that the intensity of the light from the light source decreases, both the first photodetector 101 and the second photodetector 102 will receive a corresponding decrease in the amount of light, and hence the value of the first photocurrent 104 and the second photocurrent 105 decreases in corresponding manner. When the photocurrents 104, 105 decreases, the output current 107 I_{Yout} according to (4) remains unchanged. Therefore, the output current 107 and hence the displacement information of the device is independent of brightness.

In another aspect of the invention, a third and a fourth photodetector can be further arranged in the optical position sensor to implement a two-dimensional brightness independent optical position sensor for detecting a two-dimensional movement. In this arrangement, the photodetectors are arranged around a central location, with the first and second photodetectors arranged parallel to a first axis, and the third and fourth photodetectors arranged parallel to a second axis, wherein the first axis and second axis at an angle with respect to each other.

The third and fourth photodetectors are arranged such that the encoding means is able to interfere with the path of light from the light source to the photodetectors, and when the light received by the third photodetector increases, the light received by the fourth photodetector decreases correspondingly in a complementary manner.

A third and a fourth photocurrents are generated by the third and fourth photodetectors, respectively, which photocurrents are received by a further optical comparator, or known as a second optical comparator. The second optical comparator compares the third and fourth photocurrents and outputs a further output signal, or known as a second output signal, which is proportional to a function of the third and fourth photocurrents. The second output signal provides the displacement information of the device parallel to the second axis. Similarly, the first and second photocurrents generated by the first and second photodetectors are compared in the optical comparator, or known as a first optical comparator, to produce the output signal, or known as a first output signal, which first output signal provides the displacement information of the device parallel to the first axis.

Therefore by obtaining the displacement information of the device parallel to the first and second axis from the first and second output signals, respectively, the two-dimensional displacement information of the device can be determined.

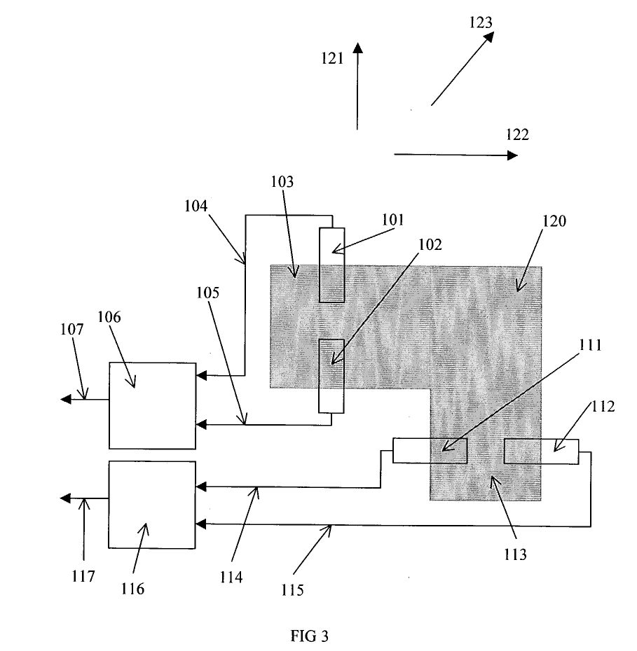

FIG. 3 shows the arrangement of the two-dimensional optical position sensor according to the further preferred embodiment of the invention.

In the further preferred embodiment of the invention, the first axis and the second axis are perpendicular to each other. The encoding means comprises an L-shaped element 120 such that when the encoding means interferes with the path of light, an L-shaped shadow of the L-shaped element 120 is cast on the photodetectors. The L-shaped element 120 further comprises a first leg 103 and a second leg 113. The first photodetector 101 and the second photodetector 102 are at a distant from each other and are arranged parallel to the first axis in a direction perpendicular to the first leg 103 of the L-shaped element 120, such that the first leg 103 of the L-shaped element 120 is able to interfere with the light incident on the first and second photodetectors 101, 102 in a complementary manner. The third photodetector 111 and the fourth photodetector 112 are at a distant from each other, and are arranged parallel to the second axis in a direction perpendicular to the second leg 113 of the L-shaped element 120, such that the second leg 113 of the L-shaped element 120 is able to interfere with the light incident on the third and fourth photodetectors 111, 112 in a complementary manner.

The first and second photocurrents 104, 105 generated by the first and second photodetectors 101, 102 are received by the first optical comparator 106. The first optical comparator 106 compares the first and second photocurrents 104, 105 and outputs the first output signal 107 which is proportional to the function of the first and second photocurrents 104, 105 according to equation (2). Similarly, the third and fourth photocurrents 114, 115 generated by the third and fourth photodetectors 111, 112 are received by the second optical comparator 116. The second optical comparator 116 compares the third and fourth photocurrents 114, 115 and outputs the second output signal 117 which is proportional to the function of the third and fourth photocurrents 114, 115 given by the following:

f(I_{X1}, I_{X2})=(I_{X1}−I_{X2})/(I_{X1}+I_{X2}) (5)

wherein

I_{X1} is the third photocurrent, and

I_{X2} is the fourth photocurrent.

And therefore, the output signal 117 is related to the function (5) by:

I_{Xout}=CX*(I_{X1}−I_{X2})/(I_{X1}+I_{X2}) (6)

wherein

I_{Xout} is the second output current 117, and

CX is a constant.

When the L-shaped element 120 of the encoding means moves in an upward direction 121 parallel to the first axis, the amount of light received by the first photodetector 101 decreases and the amount of light received by the second photodetector 102 increases correspondingly. Hence, the first output signal 107 produced by the first optical comparator 106 changes accordingly to the function of the first and second photocurrents 104, 105 according to equation (2). There is no change in the amount of light received by both the third and fourth photodetectors 114, 115 and hence the photocurrents remain unchanged. Therefore, the second output signal also remains unchanged since the function of the third and fourth photocurrent is constant.

When the L-shaped element 120 of the encoding means moves towards the right direction 122 parallel to the second axis, the amount of light received by the third photodetector 111 increases and the amount of light received by the fourth photodetector 112 decreases correspondingly. Hence, the second output signal 117 produced by the second optical comparator 116 changes accordingly to the function of the third and fourth photocurrents 114, 115 according to equation (6). The first output signal 107 remains unchanged since there is no change in the amount of light received by the first and second photodetectors 101, 102.

When the encoding means 103 moves towards the top-right direction 123, the amount of light received by the second and third photodetectors 102, 111 increases and the amount of light received by the first and fourth photodetectors 101, 112 decreases correspondingly. Therefore, the values of the first and second output signals 107, 117 are changed to reflect the corresponding changes in the function of the photocurrents 104, 105, 114, 115 according to equation (2) and (6).

By detecting the values of the first and second output signals 107, 117, the two-dimensional movement of the encoding means, and hence the two-dimensional movement of the device connected, directly or indirectly, to the encoding means can be calculated.

The arrangement according to the further preferred embodiment of the invention is an area-efficient optical position sensor for sensing a two-dimensional movement, without being dependent on the brightness or intensity of the light emitted on the photodetectors by the light source.

It should be noted that in another alternative embodiment, the first and second photocurrents 104, 105 may be related by the function according to equation (3), and the first output signal 107 from the first optical comparator 106 is thus given by equation (4). Similarly, the third and fourth photocurrents 114, 115 may be related by the following function:

f(I_{X1}, I_{X2})=I_{X1}/I_{X2} (7)

and the second output signal 117 produced by the second optical comparator 116 is thus defined by the following equation:

I_{Xout}=C2*(I_{X1}/I_{X2}) (8)

wherein

C2 is a constant.

While the different embodiments of the invention have been described, they are merely illustrative of the principles of the invention. Other embodiments and configurations may be devised without departing from the spirit of the invention and the scope of the appended claims.

What is claimed is:

1. A brightness independent optical position sensor, comprising
a first photodetector and a second photodetector;
an encoding means configured to interfere with a path of light incident on the first and second photodetectors such that when the light received by the first photodetector increases due to movement of the encoding means, the light received by the second photodetector decreases correspondingly in a complementary manner; and
an optical comparator unit which receives a first photocurrent and a second photocurrent from the first photodetector and the second photodetector, respectively, and produces an output signal which is proportional to a function of the first and second photocurrents.

2. The brightness independent optical position sensor according to claim 1, wherein the function of the first and second photocurrents is defined by the following expression:
f(I_{Y1}, I_{Y2})=(I_{Y1}−I_{Y2})/(I_{Y1}+I_{Y2})
wherein
I_{Y1} is the first photocurrent, and
I_{Y2} is the second photocurrent.

3. The brightness independent optical position sensor according to claim 1, wherein the function of the first and second photocurrents is defined by the following expression:
f(I_{Y1}, I_{Y2})=I_{Y1}/I_{Y2}
wherein
I_{Y1} is the first photocurrent, and
I_{Y2} is the second photocurrent.

4. The brightness independent optical position sensor according to claim 1, further comprising
a third photodetector and a fourth photodetector arranged such that the encoding means is able to interfere with the path of light incident on the third and fourth photodetectors in a way that when the light received by the third photodetector increases, the light received by the fourth photodetector decreases correspondingly in a complementary manner;
a further optical comparator unit which receives a third photocurrent and a fourth photocurrent from the third photodetector and the fourth photodetector, respectively, and produces a further output signal which is proportional to a function of the third and fourth photocurrents;
wherein the first and second photodetectors are arranged parallel to a first axis, and the third and fourth photodetectors are arranged parallel to a second axis;
wherein the first and second axis are at an angle with respect to each other.

5. The brightness independent optical position sensor according to claim 4, wherein the function of the third and fourth photocurrents is defined by the following expression:
f(I_{X1}, I_{X2})=(I_{X1}−I_{X2})/(I_{X1}+I_{X2})
wherein
I_{X1} is the third photocurrent, and
I_{X2} is the fourth photocurrent.

6. The brightness independent optical position sensor according to claim 4, wherein the function of the third and fourth photocurrents is defined by the following expression:
f(I_{X1}, I_{X2})=I_{X1}/I_{X2}
wherein
I_{X1} is the third photocurrent, and
I_{X2} is the fourth photocurrent.

7. The brightness independent optical position sensor according to claim 4, wherein the first axis and the second axis are perpendicular to each other.

8. The brightness independent optical position sensor according to claim 4,
wherein the encoding means comprises an L-shaped element such that when the encoding means interferes with the path of light, an L-shaped shadow of the L-shaped element is cast on the photodetectors; and
wherein the photodetectors are arranged such a first leg of the L-shaped element of the encoding means is able to interfere with the path of light incident on the first and second photodetectors in a complementary manner, and a second leg of the L-shaped element of the encoding means is able to interfere the path of light incident on the third and fourth photodetectors in a complementary manner.

9. The brightness independent optical position sensor according to claim 7,
wherein the encoding means comprises an L-shaped element such that when the encoding means interferes with the path of light, an L-shaped shadow of the L-shaped element is cast on the photodetectors; and
wherein the photodetectors are arranged such a first leg of the L-shaped element of the encoding means is able to interfere with the path of light incident on the first and second photodetectors in a complementary manner, and a second leg of the L-shaped element of the encoding means is able to interfere the path of light incident on the third and fourth photodetectors in a complementary manner.
